(19) United States
(12) Patent Application Publication
(10) Pub. No.: US 2017/0268551 A1
(43) Pub. Date: Sep. 21, 2017

(54) Hidden Positioning Fastener

(71) Applicant: Lih Yeu Seng Industries, Co., Ltd., Tainan City (TW)

(72) Inventor: Chin-Teng Hsu, Tainan City (TW)

(21) Appl. No.: 15/075,254

(22) Filed: Mar. 21, 2016

(51) Int. Cl. F16B 12/46

(52) U.S. Cl. CPC F16B 12/46

(57) ABSTRACT

An improved hidden positioning fastener is provided for use with wood or simulated-wood (plastic) structural components. The hidden positioning fastener includes a separation plate and a plurality of positioning sections which extend in opposite directions from the front and rear sides of the separation plate and are alternately arranged along the periphery of the separation plate. The positioning sections are configured to be driven into predetermined portions of two adjacent structural components to be connected by the hidden positioning fastener. The lengths of the positioning sections can be designed according to the internal stress and allowable tension of the structural components. Moreover, guide holes can be formed in the structural components so that the structural components can be fixed in position rapidly.

### BACKGROUND OF THE INVENTION

1. Technical Field

The present invention relates to positioning fasteners for use with structural components and more particularly to an improved hidden positioning fastener which can be used with ease to join the to-be-connected surfaces of two adjacent structural components and thereby fix the structural components in position rapidly.

2. Description of Related Art

Positioning fasteners for connecting structural components are available in various forms, including nails (e.g., iron nails, wood nails) and screws (e.g., wood screws). It is also feasible to dispense with such positioning fasteners and fix two adjacent structural components together by ultrasound bonding, chemical adhesive bonding, and/or the like. The mortise-and-tenon joint is equally capable of securing adjacent wood components of predetermined shapes. While the aforementioned positioning devices are effective in positioning and fastening, be they hidden from view after use or otherwise, their application is time-consuming, labor-intensive, or even environmentally unfriendly.

In view of the above, the present invention provides a novel form of positioning fasteners for connecting two adjacent structural components in a hidden manner. The positioning fastener disclosed herein features easy operation and can fix two adjacent structural components in position rapidly.

### BRIEF SUMMARY OF THE INVENTION

The present invention provides an improvement over the conventional positioning devices, or more particularly over the conventional hidden positioning fasteners, by disclosing a novel hidden positioning fastener which includes a separation plate and a plurality of positioning sections. The positioning sections extend in opposite directions from the front and rear sides of the separation plate and can be driven into predetermined portions of two adjacent to-be-connected structural components, which can be made of wood or simulated wood (plastic). If necessary, at least one guide hole can be formed in the predetermined portions of the two structural components, with a filler (e.g., a water-based glue, silicone, etc.) injected into the hole, so that the two structural components can be fixed in position rapidly.

The primary objective of the present invention is to provide a hidden positioning fastener applicable to two adjacent structural components, wherein the hidden positioning fastener includes a separation plate of a predetermined shape and a plurality of positioning sections. The separation plate serves to counteract the stress of, and increase the pressure that can be borne by, the two adjacent structural components. The positioning sections extend in opposite directions from the front and rear sides of the separation plate, are alternately arranged along the periphery of the separation plate, and can be driven into the to-to-connected portions of the two adjacent structural components to fix the structural components in position.

The second objective of the present invention is to provide a hidden positioning fastener applicable to two adjacent structural components, wherein the hidden positioning fastener includes a basic positioning fastener and an auxiliary positioning fastener. The basic positioning fastener includes a separation plate of a predetermined shape and a plurality of positioning sections extending in opposite directions from the front and rear sides of the separation plate of the basic positioning fastener. The separation plate of the basic positioning fastener is centrally formed with a hole. The auxiliary positioning fastener includes a separation plate of a predetermined shape and a plurality of positioning sections. The positioning sections of the auxiliary positioning fastener extend in opposite directions, and in different orientations, from the front and rear sides of the separation plate of the auxiliary positioning fastener. The positioning section(s) on either of the front and rear sides of the separation plate of the auxiliary positioning fastener are passed through the hole of the basic positioning fastener such that the separation plate of the auxiliary positioning fastener is pressed against the periphery of the hole of the basic positioning fastener. The positioning sections on both the front and rear sides of the separation plate of each of the basic positioning fastener and the auxiliary positioning fastener are driven into the to-be-connected portions of the two adjacent structural components to fix the structural components in position.

The third objective of the present invention is to provide a hidden positioning fastener applicable to two adjacent structural components, wherein the hidden positioning fastener includes a separation plate of a predetermined shape and a plurality of positioning sections which extend in opposite directions from the front and rear sides of the separation plate and each of which has an active side formed with a plurality of barbs arranged, if so desired, at a predetermined spacing. The positioning sections on both the front and rear sides of the separation plate are driven into the to-to-connected portions of the two adjacent structural components in order for the barbs on the active sides of the positioning sections to fasten the two adjacent structural components together and thereby fix the structural components in position.

The fourth objective of the present invention is to provide the foregoing hidden positioning fastener composed of the basic and auxiliary positioning fasteners, wherein each of the positioning sections has an active side formed with a plurality of barbs, which may be arranged at a predetermined spacing. The barbs are provided to ensure that the two adjacent structural components are securely fixed in position.

The fifth objective of the present invention is to provide the foregoing hidden positioning fastener composed of the basic and auxiliary positioning fasteners, wherein the separation plate of the auxiliary positioning fastener has a greater width than the hole of the basic positioning fastener.

The sixth objective of the present invention is to provide any of the foregoing hidden positioning fasteners, wherein each of the positioning sections reduces in thickness in a direction from the (corresponding) separation plate to the tip of the positioning section.

The seventh objective of the present invention is to provide a hidden positioning fastener applicable to two adjacent structural components, wherein the hidden positioning fastener includes a separation plate of a predetermined shape to counteract the stress of, and increase the pressure that can be borne by, the two adjacent structural components; and a plurality of positioning sections which extend in opposite directions from the front and rear sides of the separation plate, which are alternately arranged along the periphery of the separation plate, and each of which has a plurality of engaging teeth. The positioning sections on both the front and rear sides of the separation plate are driven into the to-be-connected portions of the two adjacent structural components to fix the structural components in position.

The eighth objective of the present invention is to provide the foregoing hidden positioning fastener having the engaging teeth, wherein each of the engaging teeth of the positioning sections increases in width in a direction toward the separation plate to ensure that the two adjacent structural components are securely fixed in position.

The ninth objective of the present invention is to provide a hidden positioning fastener applicable to two adjacent structural components, wherein: the hidden positioning fastener includes a basic positioning fastener and an auxiliary positioning fastener; the basic positioning fastener includes a separation plate of a predetermined shape and a plurality of positioning sections; the positioning sections of the basic positioning fastener extend in opposite directions from the front and rear sides of the separation plate of the basic positioning fastener, are alternately arranged along the periphery of the separation plate of the basic positioning fastener, and each have a plurality of engaging teeth; the separation plate of the basic positioning fastener is centrally formed with a hole; the auxiliary positioning fastener includes a separation plate of a predetermined shape and a plurality of positioning sections; and the positioning sections of the auxiliary positioning fastener extend in opposite directions from the front and rear sides of the separation plate of the auxiliary positioning fastener and each have a plurality of engaging teeth. The positioning section(s) on either of the front and rear sides of the separation plate of the auxiliary positioning fastener are passed through the hole of the basic positioning fastener such that the separation plate of the auxiliary positioning fastener is pressed against the periphery of the hole of the basic positioning fastener. The positioning sections of the basic and auxiliary positioning fasteners are driven into the to-be-connected portions of the two adjacent structural components to fix the structural components in position.

The tenth objective of the present invention is to provide the forgoing hidden positioning fastener composed of the basic and auxiliary positioning fasteners and having the engaging teeth, wherein each of the engaging teeth of the positioning sections increases in width in a direction toward the corresponding separation plate to ensure that the two adjacent structural components are securely fixed in position.

The eleventh objective of the present invention is provide the foregoing hidden positioning fastener composed of the basic and auxiliary positioning fasteners and having the engaging teeth, wherein the separation plate of the auxiliary positioning fastener has a greater width than the hole of the basic positioning fastener.

The twelfth objective of the present invention is to provide any of the foregoing hidden positioning fasteners, wherein the thickness and/or length of the positioning sections and the predetermined shape(s) of the separation plate(s) may vary, depending on the widths, the connecting angle, the internal stress, and the expected tension of the two adjacent structural components, in order to fix the structural components securely in position.

The thirteenth objective of the present invention is to provide any of the foregoing hidden positioning fasteners, wherein configurations associated with the separation plate(s) may vary, depending on the material and/or shape of the two adjacent structural components to be connected. For example, there may be only one row or more than one row of positioning sections, and the positioning sections may by alternately arranged or otherwise.

### BRIEF DESCRIPTION OF THE SEVERAL VIEWS OF THE DRAWINGS

FIG. 1 is a front perspective view of the positioning fastener in the first embodiment of the present invention;

FIG. 2 is a side view of the positioning fastener in FIG. 1;

FIG. 3 is a rear perspective view of the positioning fastener in FIG. 1;

FIG. 4 is an exploded front perspective view of the positioning fastener in the second embodiment of the present invention;

FIG. 5 is an assembled front perspective view of the positioning fastener in FIG. 4;

FIG. 6 is an assembled side view of the positioning fastener in FIG. 4;

FIG. 7 schematically shows how the positioning fastener in the first embodiment of the present invention is used to connect two structural components;

FIG. 8 schematically shows the structural components in FIG. 7 after the connection is completed;

FIG. 9 is a side view of the positioning fastener in the third embodiment of the present invention;

FIG. 10 is a front perspective view of the positioning fastener in FIG. 9;

FIG. 11 is a rear perspective view of the positioning fastener in FIG. 9;

FIG. 12 is an exploded front perspective view of the positioning fastener in the fourth embodiment of the present invention; and

FIG. 13 is an assembled side view of the positioning fastener in FIG. 12.

### DETAILED DESCRIPTION OF THE INVENTION

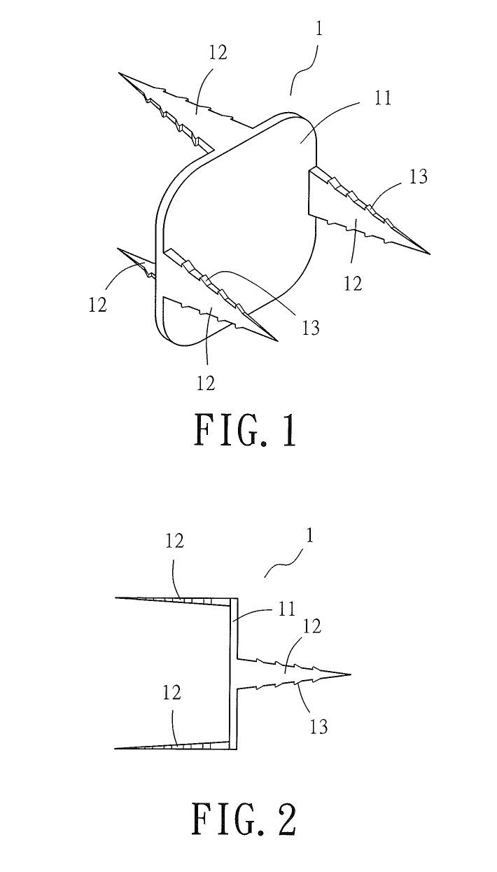

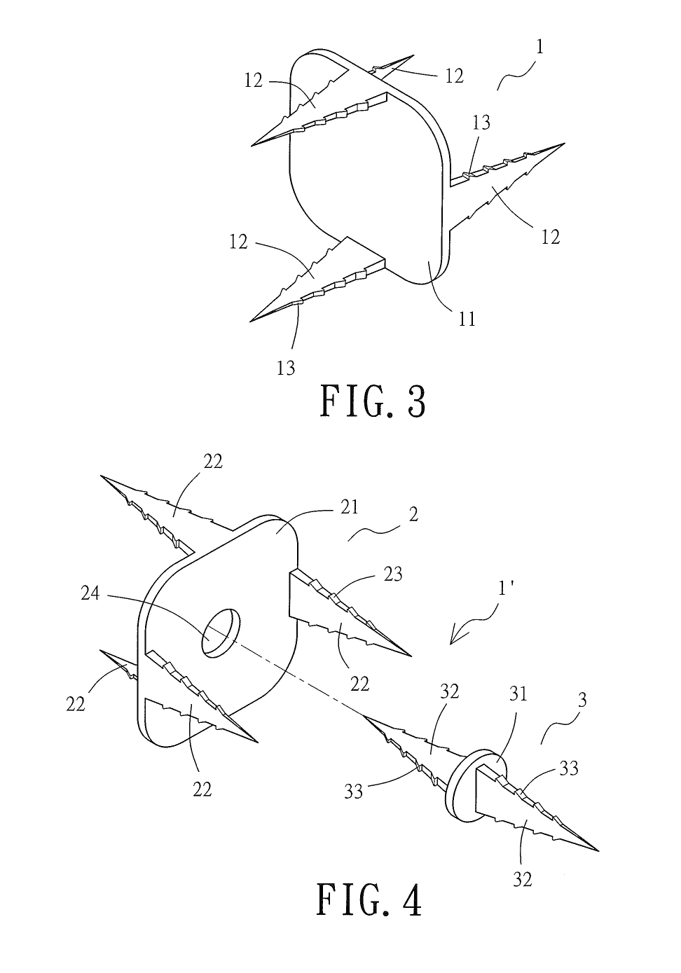

Referring to FIG. 1, FIG. 2, and FIG. 3, the hidden positioning fastener 1 in an embodiment of the present invention is configured for use between two adjacent structural components and includes a separation plate 11 of a predetermined shape and a plurality of positioning sections 12 extending in opposite directions from the front and rear sides of the separation plate 11. Each positioning section 12 is demonstrated in the drawings as a pyramid whose thickness reduces in a direction from the separation plate 11 to the tip of the pyramid.

More specifically, as shown in FIG. 1, FIG. 2, and FIG. 3, the positioning sections 12 extending in opposite directions from the front and rear sides of the separation plate 11 are alternately arranged along the periphery of the separation plate 11, and each positioning section 12 (in the shape of a pyramid, and decreasing in thickness in the direction from the separation plate 11 to the tip of the pyramid) has two active sides formed with a plurality of barbs 13. The barbs 13 may be arranged at a predetermined space.

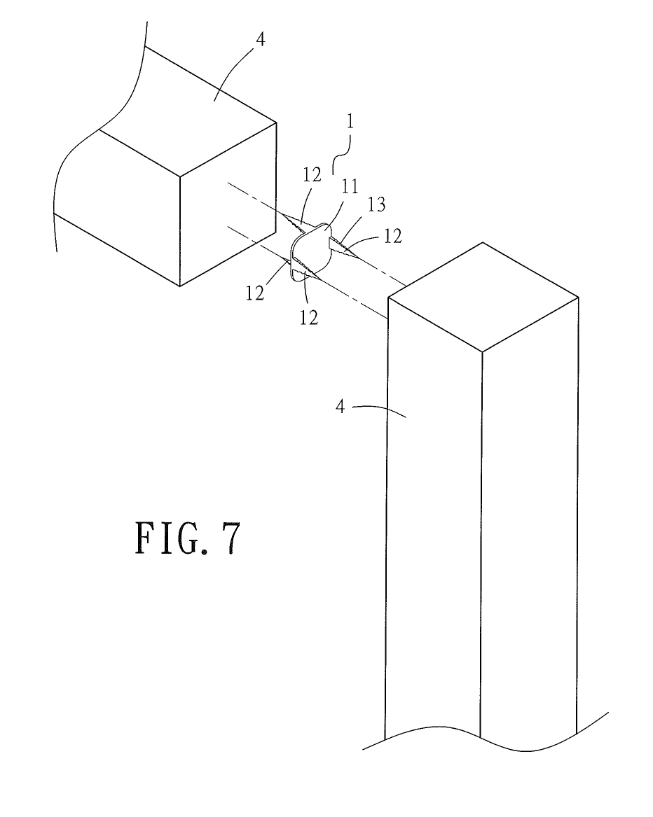

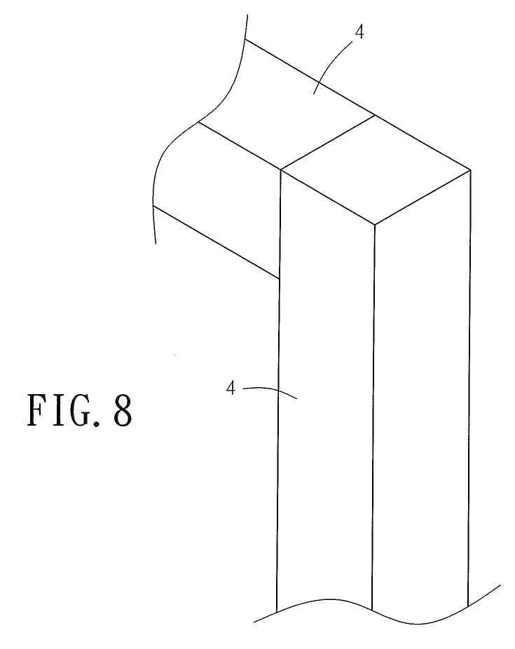

Referring to FIG. 7, in order to connect two adjacent structural components 4 with the positioning fastener 1, the positioning sections 12 on both sides of the separation plate 11 are driven into the to-be-connected portions of the two structural components 4, allowing the barbs 13 on the active sides of the positioning sections 12 to fasten the two structural components 4 together and thereby rapidly fix the two structural components 4 in position, as shown in FIG. 8.

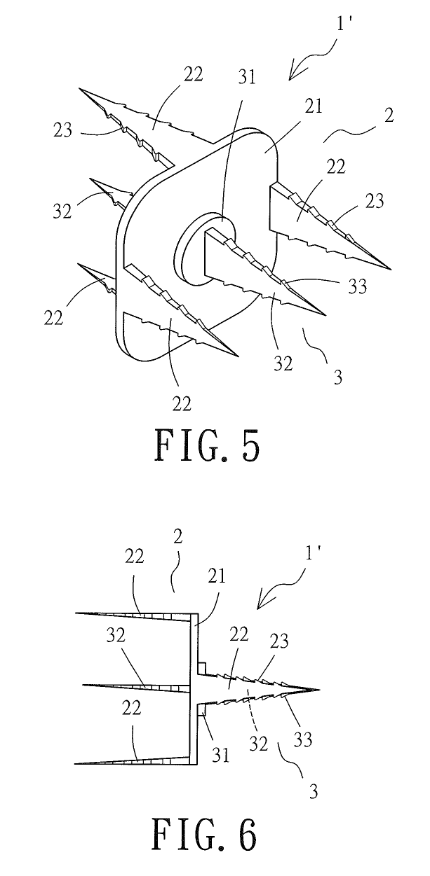

In the second embodiment as shown in FIG. 4, the hidden positioning fastener 1′ is composed of a basic positioning fastener 2 and an auxiliary positioning fastener 3. The basic positioning fastener 2 includes a separation plate 21 of a predetermined shape, a plurality of positioning sections 22, and a hole 24. The positioning sections 22, implemented as pyramids, extend in opposite directions from the front and rear sides of the separation plate 21 and are alternately arranged along the periphery of the separation plate 21. The active sides of each positioning section 22 are formed with a plurality of barbs 23. The barbs 23, which may be arranged at a predetermined spacing, are intended to provide a strong fastening effect on the two adjacent structural components to be connected. The hole 24 penetrates a central portion of the separation plate 21. The auxiliary positioning fastener 3 includes a separation plate 31 of a predetermined shape and two positioning sections 32. The positioning sections 32, implemented also as pyramids, extend in opposite directions from the front and rear sides of the separation plate 31 respectively and are perpendicular to each other in orientation. The active sides of each positioning section 32 are formed with a plurality of barbs 33, which may be arranged at a predetermined spacing. All the positioning sections 22 and 32 reduce in thickness in a direction from the separation plate 21 or 31 to the tip of each positioning section. The positioning section 32 on either side of the auxiliary positioning fastener 3 can be guided into the hole 24 of the basic positioning fastener 2, with the separation plate 31 of the auxiliary positioning fastener 3 pressed against the periphery of the hole 24 of the basic positioning fastener 2, as shown in FIG. 5 and FIG. 6, to form the positioning fastener 1′. Please note that the separation plate 31 of the auxiliary positioning fastener 3 must have a greater width than the hole 24 of the basic positioning fastener 2.

To connect two adjacent structural components with the positioning fastener 1′, the positioning sections 22 and 32 on both sides of the positioning fastener 1′ are driven into the to-be-connected portions of the structural components, in order for the barbs 23 and 33 on the active sides of the positioning sections 22 and 32 to rapidly fasten the two structural components together while holding them at the desired positions.

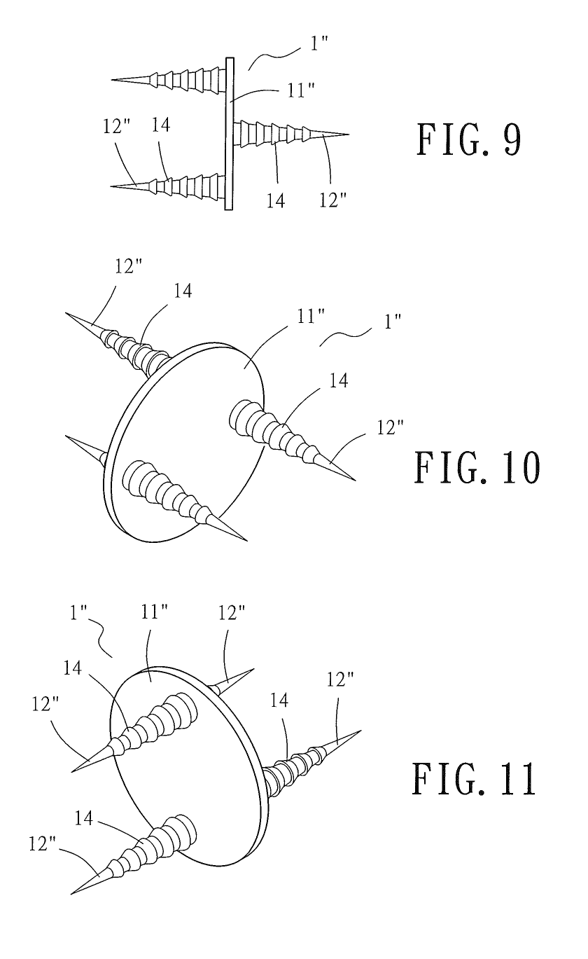

FIG. 9, FIG. 10, and FIG. 11 show the third embodiment of the present invention, in which the hidden positioning fastener 1″ includes a separation plate 11″ of a predetermined shape and a plurality of positioning sections 12″. The positioning sections 12″ extend in opposite directions from the front and rear sides of the separation plate 11″, are alternately arranged along the periphery of the separation plate 11″, and each have a plurality of engaging teeth 14. Each engaging tooth 14 increases in width in an inward direction (i.e., toward the separation plate 11″) in order to better fasten two adjacent structural components. To connect two adjacent structural components with the positioning fastener 1″, the user only has to drive the positioning sections 12″ on both sides of the positioning fastener 1″ into the to-be-connected portions of the structural components, and the structural components are immediately fixed in position.

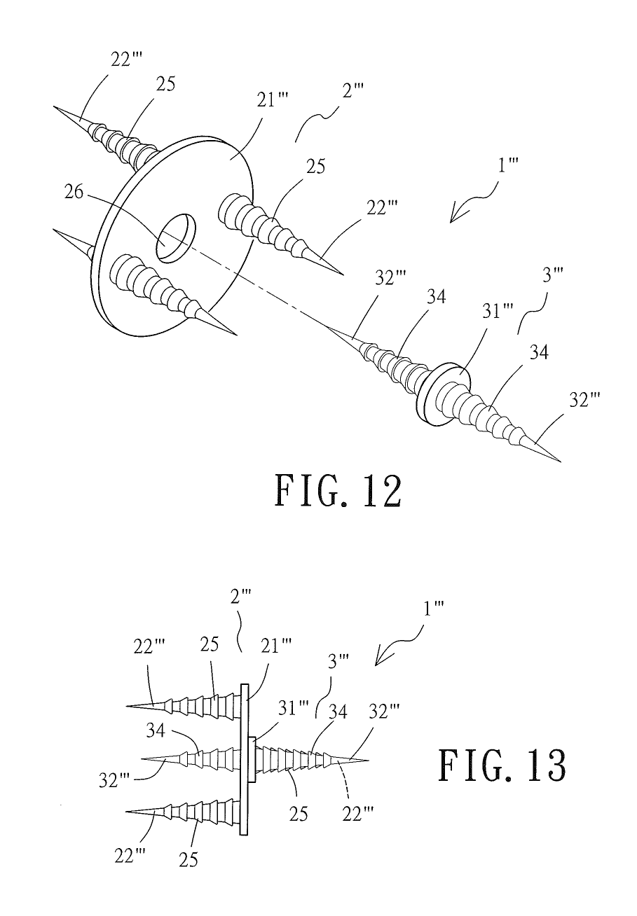

In the fourth embodiment as shown in FIG. 12, the hidden positioning fastener 1′″ is configured for use with wood furniture and is composed of a basic positioning fastener 2′″ and an auxiliary positioning fastener 3′″. The basic positioning fastener 2′″ includes a separation plate 21′″ of a predetermined shape and a plurality of positioning sections 22′″. The positioning sections 22′″ extend in opposite directions from the front and rear sides of the separation plate 21′″, are alternately arranged along the periphery of the separation plate 21′″, and each have a plurality of engaging teeth 25. In addition, a hole 26 extends through a central portion of the separation plate 21′″. The auxiliary positioning fastener 3′″ includes a separation plate 31′″ of a predetermined shape and two positioning sections 32′″. The two positioning sections 32′″ extend in opposite directions from the front and rear sides of the separation plate 31′″ respectively and each have a plurality of engaging teeth 34. The positioning section 32′″ on either side of the auxiliary positioning fastener 3″ can be guided into the hole 26 of the basic positioning fastener 2′″, with the separation plate 31′″ of the auxiliary positioning fastener 3′ pressed against the periphery of the hole 26 of the basic positioning fastener 2′″, as shown in FIG. 13. The positioning sections 22′″ and 32′″ on both sides of the resulting positioning fastener 1′″ can be driven into the to-be-connected portions of two adjacent structural components to fix the two adjacent structural components in position rapidly and securely.

The positioning fastener 1′ composed of the basic positioning fastener 2′″ and the auxiliary positioning fastener 3′″ is so designed that each engaging tooth 25 or 34 on the positioning sections 22′″ or 32′″ increases in width in an inward direction (i.e., toward the separation plate 21′″ or 31′″) to produce a strong fastening effect. Also, the separation plate 31′″ of the auxiliary positioning fastener 3′″ has a greater width than the hole 26 of the basic positioning fastener 2′″.

What is claimed is:

1. A hidden positioning fastener, applicable to wood furniture, comprising a separation plate of a predetermined shape and a plurality of non-parallel positioning sections, wherein the positioning sections extend in opposite directions from a front side and a rear side of the separation plate and are alternately arranged along a periphery of the separation plate, each said positioning section has an active side formed with a plurality of barbs, and the positioning sections on both the front side and the rear side of the separation plate are driven into to-to-connected portions of two adjacent structural components in order for the barbs on the active sides of the positioning sections to fasten the two adjacent structural components together and thereby fix the two adjacent structural components in position.

2. The hidden positioning fastener of claim 1, wherein each said positioning section reduces in thickness in a direction from the separation plate to a tip of the each said positioning section.

3. A hidden positioning fastener, applicable to two adjacent structural components, comprising a basic positioning fastener and an auxiliary positioning fastener, wherein the basic positioning fastener comprises a separation plate of a predetermined shape and a plurality of non-parallel positioning sections; the positioning sections of the basic positioning fastener extend in opposite directions from a front side and a rear side of the separation plate of the basic positioning fastener and are alternately arranged along a periphery of the separation plate of the basic positioning fastener; the separation plate of the basic positioning fastener is centrally formed with a hole; the auxiliary positioning fastener comprises a separation plate of a predetermined shape and a plurality of positioning sections; the positioning sections of the auxiliary positioning fastener extend in opposite directions, and in different orientations, from a front side and a rear side of the separation plate of the auxiliary positioning fastener; the positioning section or the positioning sections on either of the front side and the rear side of the separation plate of the auxiliary positioning fastener are passed through the hole of the basic positioning fastener such that the separation plate of the auxiliary positioning fastener is pressed against a periphery of the hole of the basic positioning fastener; and the positioning sections on both the front side and the rear side of the separation plate of each of the basic positioning fastener and the auxiliary positioning fastener are driven into to-be-connected portions of the two adjacent structural components to fix the two adjacent structural components in position.

4. The hidden positioning fastener of claim 3, wherein each said positioning section of the basic positioning fastener and of the auxiliary positioning fastener has an active side formed with a plurality of barbs, in order to ensure that the two adjacent structural components are securely fixed in position.

5. The hidden positioning fastener of claim 3, wherein the separation plate of the auxiliary positioning fastener has a greater width than the hole of the basic positioning fastener.

6. The hidden positioning fastener of claim 3, wherein each said positioning section of the basic positioning fastener reduces in thickness in a direction from the separation plate of the basic positioning fastener to a tip of the each said positioning section, and each said positioning section of the auxiliary positioning fastener reduces in thickness in a direction from the separation plate of the auxiliary positioning fastener to a tip of the each said positioning section.

7. The hidden positioning fastener of claim 3, wherein each said positioning section of the basic positioning fastener and of the auxiliary positioning fastener has an active side formed with a plurality of non-parallel engaging teeth such that, when the positioning sections on both the front side and the rear side of the separation plate of each of the basic positioning fastener and the auxiliary positioning fastener are driven into the to-be-connected portions of the two adjacent structural components, the two adjacent structural components are fixed in position.

8. The hidden positioning fastener of claim 7, wherein each said engaging tooth of the positioning sections of the basic positioning fastener increases in width in a direction toward the separation plate of the basic positioning fastener, and each said engaging tooth of the positioning sections of the auxiliary positioning fastener increases in width in a direction toward the separation plate of the auxiliary positioning fastener, in order to ensure that the two adjacent structural components are securely fixed in position.

9. The hidden positioning fastener of claim 7, wherein the separation plate of the auxiliary positioning fastener has a greater width than the hole of the basic positioning fastener.

10. A hidden positioning fastener, applicable to wood furniture, comprising a separation plate of a predetermined shape and a plurality of non-parallel positioning sections, wherein the positioning sections extend in opposite directions from a front side and a rear side of the separation plate, are alternately arranged along a periphery of the separation plate, and each have a plurality of engaging teeth; and the positioning sections on both the front side and the rear side of the separation plate are driven into to-be-connected portions of two adjacent structural components to fix the two adjacent structural components in position.

11. The hidden positioning fastener of claim 10, wherein each said engaging tooth of the positioning sections increases in width in a direction toward the separation plate, in order to ensure that the two adjacent structural components are securely fixed in position.
